(19) United States
(12) Patent Application Publication
(10) Pub. No.: US 2024/0159141 A1
(43) Pub. Date: May 16, 2024

(54) MOBILE DEVICE FOR DYNAMOMETER CARD PROCESSING

(71) Applicant: Oilify New-tech Solutions Inc., Invermere (CA)

(72) Inventors: Jeffrey Charles SAPONJA, Invermere (CA); Colin Harry HEIDEL, Lac Ste. Anne County (CA)

(21) Appl. No.: 18/508,209

(22) Filed: Nov. 13, 2023

Related U.S. Application Data
(60) Provisional application No. 63/424,615, filed on Nov. 11, 2022.

(51) Int. Cl. E21B 47/009; G06T 7/10

(52) U.S. Cl. CPC E21B 47/009; G06T 7/10; E21B 2200/20

(57) ABSTRACT

The present disclosure relates to a mobile device comprising one or more processors and one or more memories storing instructions that when executed by the one or more processors configure the mobile device to output a pump operating condition based on an input image representing a pump card. The pump operating condition may be determined based on an analysis of several sections or quadrants of a pump card, which can provide a more complete picture of the issues facing the pump, and provide corrective action.

### RELATED APPLICATIONS

This application claims the benefit of and priority to U.S. Provisional Patent Application No. 63/424,615, filed Nov. 11, 2022, the contents of which are incorporated herein by reference.

### TECHNICAL FIELD

The present disclosure relates generally to the field of dynamometer card processing.

### BACKGROUND

Sucker-rod pumping systems are a commonly used type of artificial lift method for production wells in the oil and gas industry. FIG. 1 illustrates a typical sucker-rod pumping system. A sucker-rod pumping system is composed of several components, some of which operate aboveground, while other parts operate underground, i.e., down the well. Basic elements of a sucker-rod pumping system include the prime mover, pumping unit (e.g., walking beam structure), sucker rod, and downhole pump. Operation of a sucker-rod pumping system can be monitored by a dynamometer 100 installed on the polished rod of the pumping unit. The dynamometer 100 is used to measure load on the polished rod and plot the load in relation to the rod displacement as the pumping system moves through a pump cycle. Data that is generated by the dynamometer 100 is commonly represented in the form of dynamometer cards. One type of dynamometer card is a pump card. The pump card represents the relationship between the displacement and load of the sucker-rod pump over a pump cycle. The pump card shape generally reflects the condition of the pumping system, and different conditions can be indicated by typical characteristics on the pump cards

Thousands of sucker-rod pumping systems can be spread out over multiple large oilfields that operate for decades. It can be difficult to monitor and manage these production units. Dynamometer card diagnosis is a widely adopted method to evaluate the working conditions of sucker-rod pumping systems. Although automated centralized data collection and analysis systems are being developed to aid in dynamometer card diagnosis, the process is still largely a manual process that is performed on-site by an operator or other technician. The manual recognition and diagnosis of pump working conditions can be a time-consuming and labor-intensive task that requires the operator to have specific knowledge.

Accordingly, there is a need for a cost-effective system that can enable quick and accurate dynamometer card based diagnosis to be performed, especially in the context of legacy environments that may not be connected to centralized data collection and analysis systems. Additionally, there is a need for quickly and easily determining the corrective actions that must be taken based on the diagnosis.

### Summary

According to one aspect of the disclosure is a method comprising: obtaining, at a mobile device, an input image representing a pump card; mapping the input pump card to one of a plurality of possible pump operating conditions; and outputting, at the mobile device, the mapped pump operating condition.

According to a further aspect is a mobile device comprising one or more processors and one or more memories storing instructions that when executed by the one or more processors configure the mobile device to output a pump operating condition based on an input image representing a pump card.

### BRIEF DESCRIPTION OF THE DRAWINGS

FIG. 1 is a schematic diagram of a typical sucker-rod pumping system.

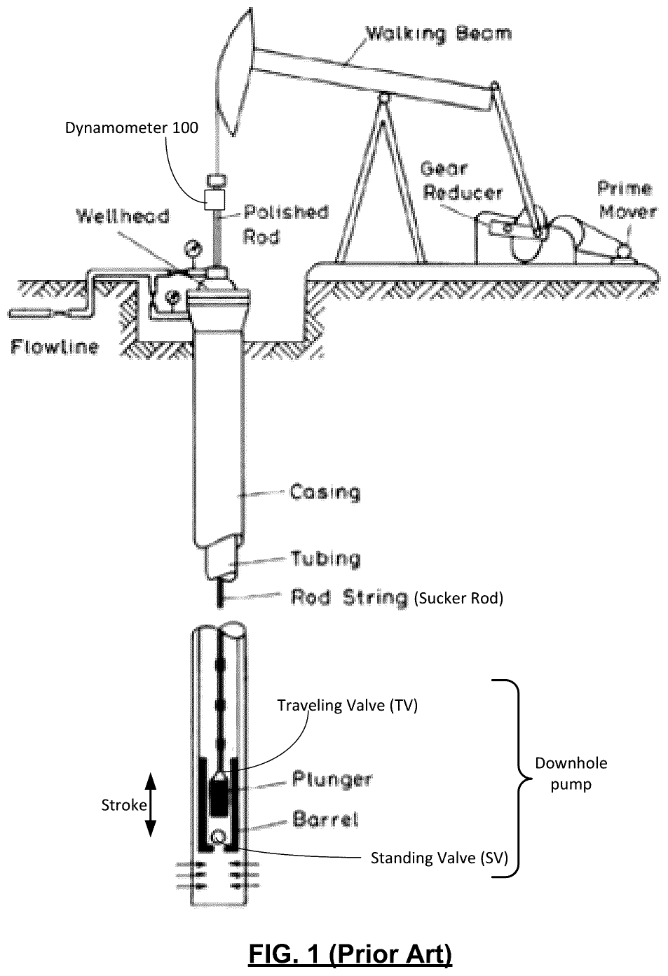

FIG. 2 is diagram illustrating an example of a theoretical pump card shape under a static load.

FIG. 3 shows examples of common pump card shapes.

FIG. 4 illustrates an environment in which a mobile device configured to function as pump card analysis device can operate, according to example embodiments.

FIG. 5 illustrates a system by which the pump card is separated into quadrants for easy reference.

FIG. 6 shows a block diagram illustrating a segment based pump card analysis according to an example embodiment.

FIG. 7 illustrates a pump card showing a condition of a pump hitting up or down with varying levels of severity and direction.

FIG. 8 illustrates a pump card displaying a condition of fluid pound, with varying levels of fullness of the pump.

FIG. 9 illustrates a pump card displaying a condition of a gas interference, with varying levels of severity.

FIG. 10A illustrates a pump card displaying a condition of tubing movement, with varying levels of severity.

FIG. 10B illustrates how a pump card image may be segmented by an image recognition function to determine the inefficiencies.

FIG. 11 illustrates a pump card displaying a condition of flowing well, rod part, inoperative pump.

FIG. 12 illustrates a pump card displaying a condition of fluid friction, with varying levels of severity.

FIG. 13 illustrates a pump card displaying a condition of worn or split barrel, with varying levels of severity.

FIG. 14 illustrates a pump card displaying a condition of bent barrel sticking pump, with varying placements.

FIG. 15 illustrates a pump card with a combination of issues.

FIG. 16 illustrates another pump card with a different combination of issues.

FIG. 17 is a flow chart outlining the steps of an example image recognition function.

FIG. 18 is a schematic block diagram illustrating an example of a device that may be used to implement the mobile device of FIG. 4.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

The following detailed description refers to the accompanying drawings. Wherever possible, the same reference numbers are used in the drawings and the following description to refer to the same or similar parts. While several example embodiments are described herein, modifications, adaptations, and other implementations are possible. For example, substitutions, additions, or modifications may be made to the components illustrated in the drawings, and the example methods described herein may be modified by substituting, reordering, or adding steps to the disclosed methods. Accordingly, the foregoing general description and the following detailed description provide examples only and are not intended to be limiting. Instead, the proper scope is defined by the appended claims.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and components have not been described in detail so as not to obscure the example embodiments described herein.

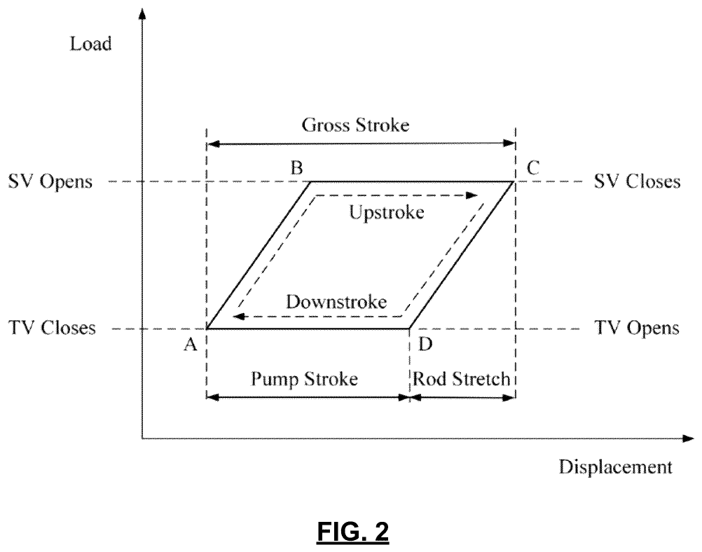

By way of context, FIG. 2 illustrates an example of a theoretical pump card shape for a static load. With the sucker rod moving up and down, the traveling valve (TV) attached to the sucker rod and the standing valve (SV) at the bottom of the pump open and close periodically, which drives the oil and gas to the surface from the underground reservoir. The journey of the sucker rod traveling from an upper dead point to a lower dead point and back up again is called a stroke. The pump card represents the relationship between the displacement and load of the sucker-rod pump over a pump cycle. The shape of the card indicates the working conditions and performance.

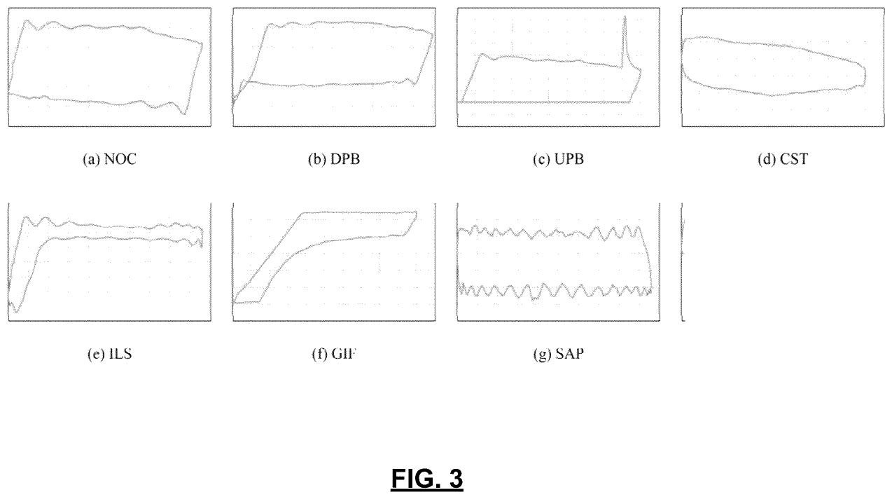

FIG. 3 illustrates example of a normal pump card shape (a) and some pump card shapes (b) to (g) that correspond to commonly known fault conditions. The pump card shapes in FIG. 3 can be categorized in FIG. 3 as (a) Normal Operating Condition (NOC); (b) downstroke pump bumping or tagging (DPB); (c) upstroke pump bumping or tagging (UPB); (d) combination of leaking standing and traveling valves (CST); (e) insufficient liquid supply (ILS); (f) gas interference or fluid pound (GIF); and (g) sand or solids in the pump (SAP).

According to example embodiments, a mobile device (for example a smart phone or a tablet style computer) is configured to function as a pump card analysis device. The mobile device can be used with legacy dynamometer monitoring equipment to enable an operator to quickly and efficiently analyze a pump card that has been generated by the legacy dynamometer monitoring equipment.

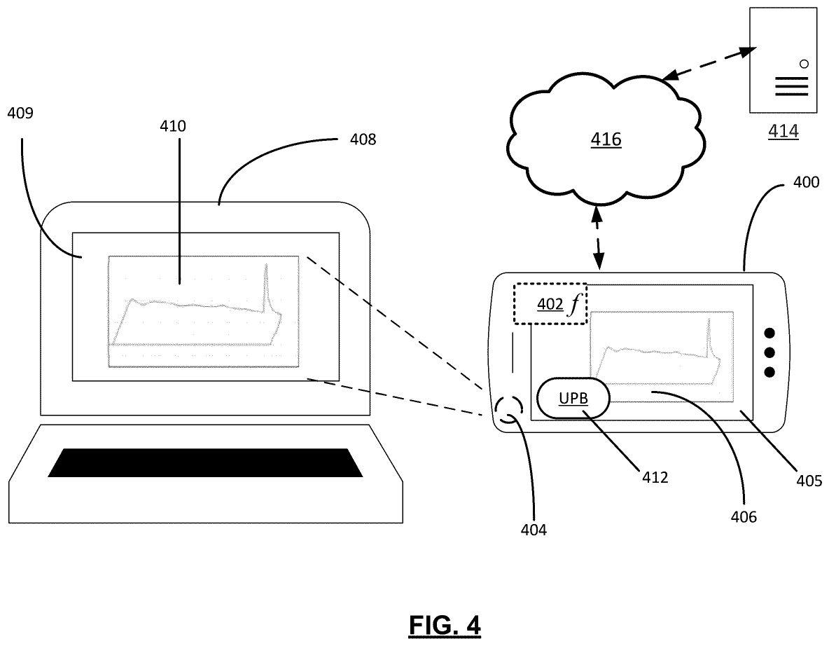

In this regard, FIG. 4 illustrates an environment in which a mobile device 400 that is configured to function as pump card analysis device can operate, according to example embodiments. In the example of FIG. 4, legacy dynamometer monitoring equipment is represented as a pump monitoring computer 408 that has an output device 409 such as a display screen. The pump monitoring computer 408 is connected to receive data from a dynamometer 100 and output a corresponding image of a pump card 410 for a human operator on the output device 409. Although the output device 409 is shown in FIG. 4 as a display screen, the output device 409 could alternatively be a printer that prints a paper copy of the pump card 410.

In the illustrated example, mobile device 400 includes a camera 404 for capturing image data and a display screen 405 for displaying information for a user of the mobile device 400. Mobile device 400 also includes a software enabled pump card analysis module 402. For example, pump card analysis module 402 may be a module that is effected by a software application that has been downloaded to the mobile device 400 through an intermediate communication network 416 from a server 414 operated by a service provider.

In one example embodiment, the onboard camera 404 of mobile device 400 can be used to capture a digital representation 406 (“pump card image”) of the pump card 410 that has been generated by pump monitoring computer 408. By way of example, the onboard camera 404 could be used to capture an image of a pump card 410 as displayed on the display screen, or to capture an image of printed copy of the pump card 410, or to capture an image of a hand-drawn representation of the pump-card 410.

The resulting pump card image 406 (which may for example be stored by mobile device 400 as an image file using any number of known image file formats, including for example “.png”) is provided as input to the pump card analysis module 402. The pump card analysis module 402 is configured to apply an on-board image recognition function ƒ to map the input pump card image 406 to one of a plurality of possible pump operating conditions, including for example the conditions represented in FIG. 3. By way of example, in the scenario of FIG. 4, the pump card analysis module 402 determines that the pump card image 406 maps to the pump operating condition upstroke pump bumping (UPB), and generates an output 412 indicating the selected pump operating condition category. In an example embodiment, the pump operating condition category output 412 and the pump card image 406 can be displayed on the display screen 405 of the mobile device 400 for viewing by a user of the mobile device 400.

In some examples, the image recognition function ƒ of pump card analysis module 402 may be implemented using a rules-based matching algorithm. In some examples, the image recognition function ƒ may be implemented using a machine learning (ML) based classification model.

In some examples, the mapping of an input pump card image 406 to a pump operating condition is based on comparisons of the pump card image to historic data. By way of example, such comparison-based mapping can be inherent in the case where image recognition function ƒ is implemented using a machine learning (ML) based classification model. In one example, image recognition function ƒ is implemented using known mobile device-based image-classification neural network classification models, including for example a convolution neural network (CNN) model. For example, such a model can be pre-trained based on a training dataset of labelled pump card images that are respectively labelled examples of the pump operating conditions shown in FIG. 3. In such examples, the image recognition function ƒ can be configured to output a prediction Pred^{f} that can includes a probability or a confidence score for each predicted operating condition and/or an indication of the favored or most likely prediction. By way of example, Table 1 below illustrates an example of information that could be presented on display screen 405 as pump operating condition category output 412 in the case where the input image 406 corresponds to a “(b) downstroke pump bumping or tagging (DPB)” condition:

TABLE 1
Pump Operating Condition Category Output 412

| | Predicted | |
|---|---|---|
| | Confidence | Selected Category |
| Operation Condition | Score | Indicator |
| (a) Normal Operating | 2% | |
| Condition | | |
| (b) downstroke pump | 95% | **MOST LIKELY** |
| bumping or tagging | | |
| (DPB) | | |
| (c) upstroke pump | 0.7% | |
| bumping or tagging (UPB) | | |
| (d) combination of | 1% | |
| leaking standing and | | |
| traveling valves (CST) | | |
| (e) insufficient liquid | 0.3% | |
| supply (ILS) | | |
| (f) gas interference or | 1% | |
| fluid pound (GIF) | | |
| (g) sand or solids in the | 1% | |
| pump (SAP) | | |

In some example embodiments, if the pump card analysis module 402 is unable to obtain a suitable match (e.g., when confidence score is below a defined threshold, for example 90%) for the pump card image 406 using the on-board image recognition function ƒ it may automatically (or with a user prompt) send the pump card image 406 via communications network 416 to remote server 414 for further analysis by a more powerful image recognition function that is hosted by remote server 414. Remote server 414 can then return the pump operating condition that its more powerful image recognition function to the mobile device 400 for the pump card analysis module 402 to use as pump operating condition output 412. Using such a system, the on-board image recognition function ƒ that is implemented on mobile device 400 can be restricted to recognizing the most common subset of operating condition categories, with less common or more difficult images (e.g., an “other category”) being sent to the remote server 414 for classification. Thus, a local on-board image recognition function ƒ can be implemented that has a relatively small storage footprint, requires a limited amount of computing power, and does not require mobile device 400 to access to a communications network, but still allows the most common operating conditions to be identified.

In some alternative examples, pump card analysis module 402 may not include an on-board image recognition function and may send all pump card images 406 to server 414 for processing. In some examples, pump card analysis module 402 may be configured to use an on-board image recognition function ƒ when predefined conditions exist (e.g., low battery power and/or no available connection to communications network 416), and to otherwise use an image recognition function provided by server 414. In some examples, pump card analysis module 402 may be configured to send all pump card images 406 and locally generated outputs 412 to server 414 for storage, analysis and/or verification purposes.

In some examples, the input pump card image 406 captured by the mobile device 400 could be based on a hand drawn sketch of a pump card. For example, camera 404 could be used to capture an image of a sketch drawn on paper. Alternatively, a touch screen of the mobile device 400 could be used as an interface for a user to manually input a sketch to mobile device 400.

In some example, the input pump card image 406 could be captured using a further camera equipped mobile device and then wirelessly transferred to mobile device 400 using one or more transmission mediums and protocols.

Accordingly, it will be appreciated mobile device 400 can be configured as a low cost, portable pump card analysis device that can be used in the field to classify pump cards that are generated by a range of legacy pump monitoring systems. Subjectivity that is inherent in human interpretation, and the expertise required by human interpretation, can be eliminated.

Communications network 416 can include any wireless network capable of enabling a plurality of communication devices to wirelessly exchange data such as, for example, a wireless Wide Area Network (WAN) 102 such as a cellular network, a wireless local area network (WLAN) 104 such as Wi-Fi™, or a wireless personal area network (WPAN) (not shown), such as Bluetooth™ based WPAN. The mobile device 400 may be configured to communicate over all of the aforementioned network types and to roam between different networks. Communications network 416 can also include a network gateway that connect to the Internet and through the Internet to server 414. The server 414 may be implemented as one or more server modules, and is typically located behind a firewall 114.

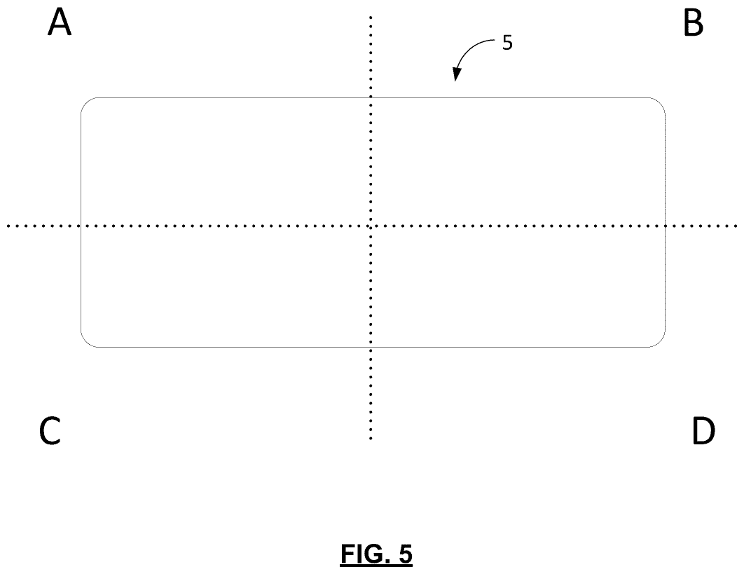

In example embodiments, a multi-step process can be applied by pump card analysis module 402 to analyze an input pump card image. For example, FIG. 5 demonstrates one potential embodiment to classify an input pump card image 5. In this embodiment, the input pump card image 5 (illustrating a full pump condition) may be separated into multiple segments, such as, for example, four quadrants (labeled A, B, C, and D in FIG. 5) for ease of reference. In different examples, the number and locations of the segments can be different from that shown in FIG. 5. Each quadrant represents a segment of the pump card shape that can be analyzed individually. In order to properly assess the reading of the pump card, the pump card analysis module 402 first processes the input pump card image to calculate (e.g., predict) a baseline determination of the pump working condition, and then further analyze each quadrant of the image to determine (e.g., predict) the severity of any faults that may be present as shown in the pump card.

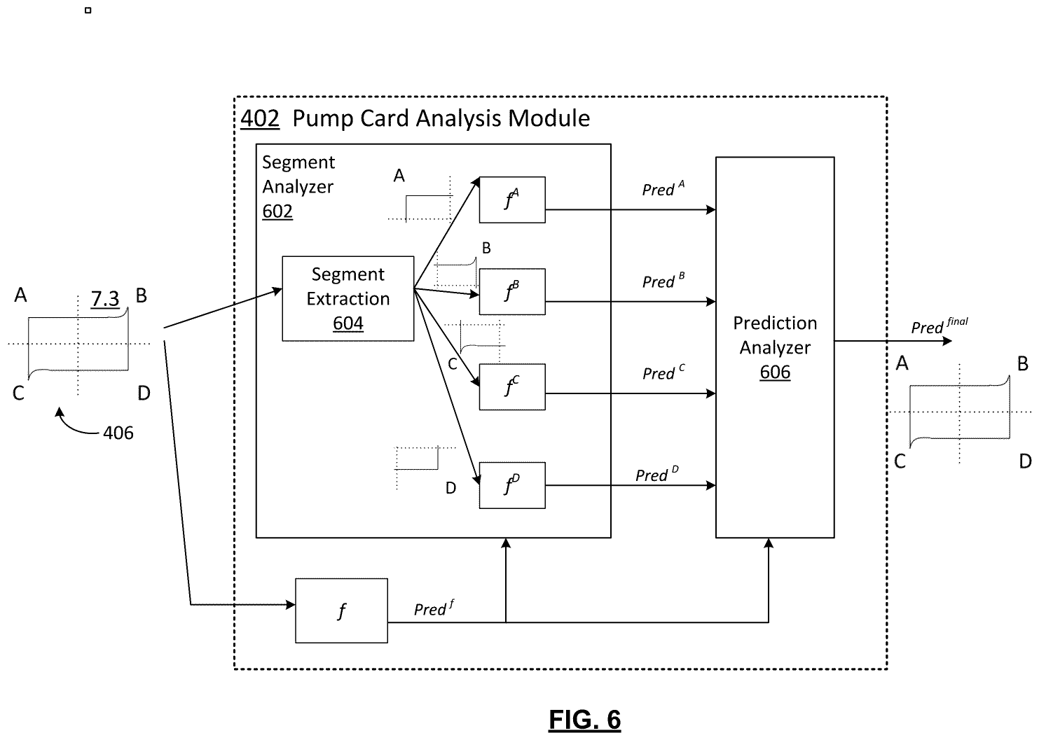

Referring now to FIG. 6, an example of a multi-stage segment based processing operation that can be performed by pump card analysis module 402 is shown in the context of an example of a “pump hitting up or down” pump condition 7.3 illustrated in an input image 406. At a first step, the pump card analysis module 402 applies image recognition function ƒ to process the pump card image 7.3 as a whole to determine a prediction Pred^{f} based on the general shape of the pump card that is represented in the image. Image recognition function ƒ in the illustrated embodiment also includes a segment analyzer module 602 that includes a segment extraction operation 604. Segment extraction operation 604 divides the input image 406 into a set of segment images. In the illustrated embodiment, the segment images are quadrant images A, B, C and D, each of which include pixilated image data for the respective quadrants of the input image 406. At a next step, the pump card analysis module 402 may apply one or more segment-based image recognition functions ƒⁱ (where i=segment index, for example A, B, C or D in the illustrated example) to analyze the extracted image data corresponding to each quadrant A, B, C, and D, and process the shape of the pump card in each quadrant to generate a respective quadrant prediction Predⁱ.

In at least some use cases, each of the segment-based image recognition functions ƒⁱ are pre-configured to make predictions based on the specific quadrant of pump card image data that they are provided with data in respect of. In some examples, one or more of the segment-based image recognition functions ƒⁱ can be rules based functions; in some examples, one or more of the segment-based image recognition functions ƒⁱ can be implemented using a respective machine learning (ML) based classification model that has been trained using a quadrant-labelled historic image training dataset to predict a classification for that quadrant from a set of predetermined candidate classifications. In some examples, the output prediction Predⁱ by a segment-based image recognition function ƒⁱ can include a probability or confidence score in a manner similar to that described above in respect of the primary full image prediction Pred^{f}.

In some examples, one or more of the segment-based image recognition functions ƒⁱ that are applied by the segment analyzer 602 to the respective pump card segment images can be selected based on the full image prediction Pred^{f} that is generated by full image prediction function ƒ. By way of example, segment analyzer 602 can have access to multiple stored sets of pre-stored segment-based image recognition functions ƒⁱ, where each set has been pre-trained for a respective full image prediction condition. The segment analyzer 602 can the select the appropriate set segment-based image recognition functions ƒⁱ to use for the image quadrants A, B, C, D based on the classification (e.g., highest probability predicted pump condition that was output by the full image prediction function ƒ.

In illustrated examples, the pump card analysis module 402 can include a prediction results prediction analyzer module 606 that can output a final prediction for the input pump card image 406 that is based on the collective predictions by full image prediction function ƒ and segment image prediction functions ƒⁱ (for i=A, B, C, and D), the final prediction can be based on a rules-based analysis of these multiple predictions. In some alternative examples, a further ML trained model can be configured to make a final prediction based on the prediction inputs to the prediction analyzer module 606.

By way of example, Table 2 below illustrates an example of information that could be presented on display screen 405 as pump operating condition prediction final in the case where the input image 406 corresponds to a “pump hitting up or down” condition that is present in pump card 7.1 as represented in input image 406 of FIG. 6:

TABLE 2
Pump Operating Condition Category Prediction f

| Full Image Prediction | Segment Predictions | Final Prediction |
|---|---|---|
| Condition: “pump | Quadrant A: | Condition: “pump |
| hitting up or | “Normal” | hitting up - Moderate |
| down” | Confidence Score: 98% | Upstroke Tag” |
| Confidence | Quadrant B: | AND |
| Score: 98% | “Moderate Upstroke | “Pump hitting |
| | Tag” | down - Moderate |
| | Confidence Score: 97% | Downstroke tag” |
| | Quadrant C: | Confidence |
| | “Moderate Downstroke | Score: 97% |
| | tag” | |
| | Confidence Score: 96% | |
| | Quadrant D: | |
| | “Normal” | |
| | Confidence Score: 97% | |

In the above example, each of the respective Segment Predictions is selected based on a predetermined number of possible quadrant specific condition classifications that can occur when the full image condition of “pump hitting up or down”. For example, for Quadrant B, the candidate prediction categories could include “Mild Upstroke Tag”; “Moderate Upstroke Tag” and “Severe Upstroke Tag” for Quadrant C, the candidate prediction categories could include “Mild Downstroke Tag”; “Moderate Downstroke Tag” and “Severe Downstroke Tag”. As indicated above, in some examples, confidence scores for the prediction can also be displayed. In some examples, the final prediction can be a combination of the “not normal” predictions. e.g., “pump hitting up—Moderate Upstroke Tag” and “Pump hitting down—Moderate Downstroke Tag”, with a confidence score that is based on an average of all of the confidence scores for the input predictions.

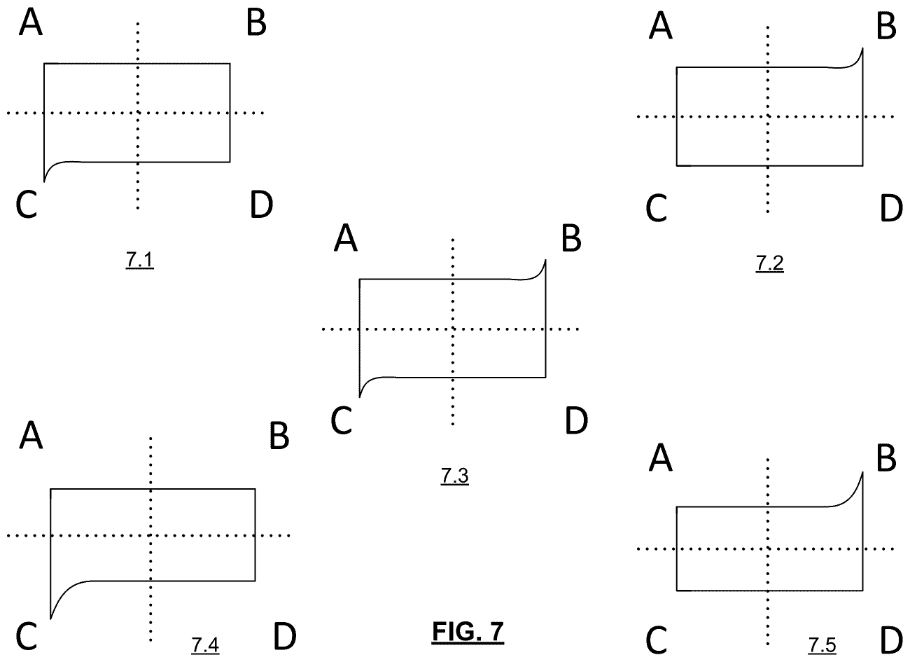

In order to illustrate possible different quadrant predictions, FIG. 7 illustrates varying levels of severity for a pump cards 7.1, 7.2, 7.3, 7.4 and 7.5. showing a pump fault condition of pump hitting up or down, including the pump card 7.3 shown as input to pump card analysis module 402 in FIG. 6. These illustrations are meant as examples, and are not exhaustive of the potential displayed pump cards relating to this issue. For example, pump card 7.1 shows a moderate downstroke issue without any upstroke issue, and 7.2 shows a moderate upstroke issue without any downstroke issue. Pump card 7.4 shows a severe downstroke issue without any upstroke issue, and pump card 7.5 shows a severe upstroke issue without any downstroke issue. As shown in pumpcard 7.3, there may be both a moderate upstroke and a moderate downstroke issue on the same pump card.

In the case of FIG. 7, the respective prediction outputs for each pump card 7.1 through 7.5 could be as illustrated in the following Table 3:

TABLE 3
Predictions for FIG. 7 Pump Cards

| | Full | Quad A | Quad B | Quad C | Quad D | |
|---|---|---|---|---|---|---|
| Card | Image | predic- | predic- | predic- | predic- | |
| ID | Prediction | tion | tion | tion | tion | Final |
| 7.1 | pump | Normal | Normal | Moderate | Normal | pump |
| | hitting up | | | Down- | | hitting |
| | or down | | | stroke | | down - |
| | | | | Tag | | Moderate |
| 7.2 | pump | Normal | Moderate | Normal | Normal | pump |
| | hitting up | | Upstroke | | | hitting |
| | or down | | Tag | | | up - |
| | | | | | | Moderate |
| 7.3 | pump | Normal | Moderate | Moderate | Normal | pump |
| | hitting up | | Upstroke | Down- | | hitting |
| | or down | | Tag | stroke | | down - |
| | | | | Tag | | Moderate |
| | | | | | | AND |
| | | | | | | pump |
| | | | | | | hitting |
| | | | | | | up - |
| | | | | | | Moderate |
| 7.4 | pump | Normal | Normal | Severe | Normal | pump |
| | hitting up | | | Down- | | hitting |
| | or down | | | stroke | | down - |
| | | | | Tag | | Severe |
| 7.5 | pump | Normal | Severe | | Normal | pump |
| | hitting up | | Upstroke | | | hitting |
| | or down | | Tag | | | up - |
| | | | | | | Severe |

As noted above, in example embodiments, probability values (e.g., confidence scores) can also be provided for each of the prediction in FIG. 3. As shown above, by analyzing each quadrant individually and at a finer degree, the image recognition function would be able to determine the true cause of the issue.

In at least some examples, the predictions output by the segment image prediction functions ƒⁱ can also be used to double check the full image prediction made by full image prediction function ƒ. For example, prediction analyzer operation 606 can be configured to confirm that the segment image predictions Predⁱ in fact generate outputs that are expected in view of the full image prediction Pred^{f}. For example, if full image prediction Pred^{f} indicates a pump hitting up or down condition, whereas all four segment image predictions Predⁱ indicate “Normal”, the prediction analyzer operation 606 may determine that the full image prediction Pred^{f} cannot be relied on as the four segment image predictions Predⁱ collectively do not match any known pump hitting up or down condition. This ambiguity could be used to trigger an action such as communicating the presence of inconclusive results to the user via display screen 405, or alternatively, sending the input image 406 to a more sophisticated remote classification function resident on server 414 via network 416 for further analysis and feedback.

Although the segment image prediction functions ƒⁱ can, as noted above, be unique sets of image prediction functions ƒⁱ that are configured in respect of each possible full pump card condition, in some examples, the same segment image prediction functions ƒⁱ can be configured to make quadrant predictions for multiple types of full pump card conditions. In such cases, the efficacy of the segment image prediction functions ƒⁱ as a double check for the full image prediction Pred^{f} can be comprehensive.

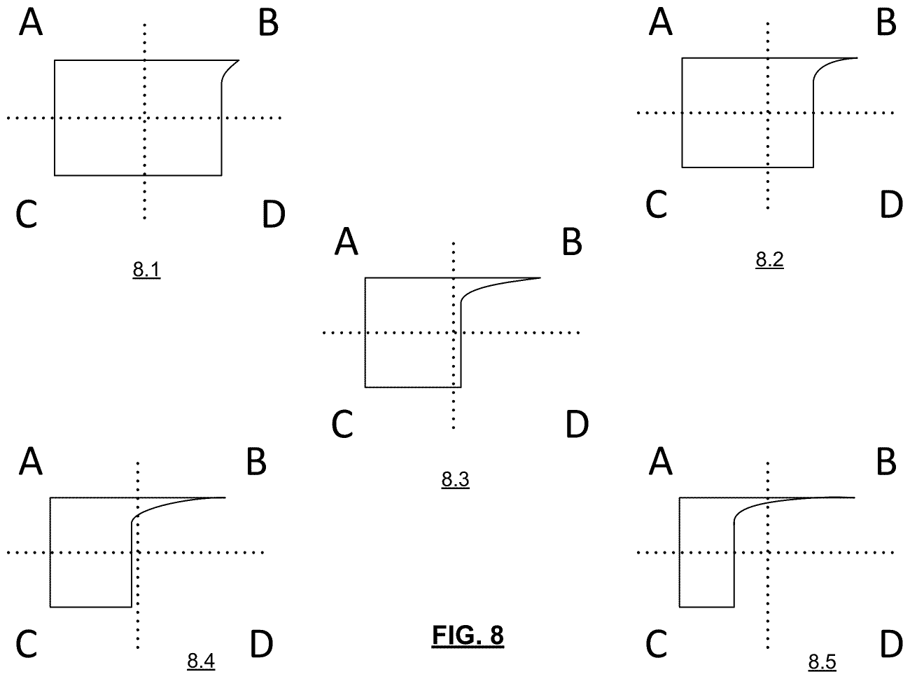

FIGS. 8 to 14 each illustrate additional respective pump card conditions with different types of sub-conditions that can be identified through quadrant analysis.

FIG. 8 illustrates varying levels of severity of the pump card condition, namely fluid pound, wherein the severity of the condition corresponds to the percent fullness of a pump. These illustrations are meant as examples, and are not exhaustive of the potential displayed pump cards relating to this issue. The following FIG. 8 pump cards can correspond to the following sub-categories of a fluid pound condition: pump card 8.1—pump fullness 90%, indicative of beginning from a pump-off time; pump card 8.2—pump fullness 75% corresponding to begin fluid pound; pump card 8.3—pump fullness 65% corresponding to moderate fluid pound; pump card 8.4—pump fullness 45% corresponding to severe fluid pound; pump card 8.5—pump fullness 30% corresponding to very severe fluid pound. When viewing an image as a whole, it may be difficult to tell the exact issue when the severity is small, such as in pump card 8.1. However, when the quadrants are analyzed, the shape of the corner in quadrant B together with the analysis of the other three quadrants can show the level of severity, and in some example embodiments, rule out other possible issues.

In addition, when viewing the image as a whole, it can be difficult to tell the exact level of severity. For example, when viewed as a whole, the pump cards 8.3 and 8.4 look extremely similar, and it would be difficult to tell which one is more severe, and which specific actions should be taken. It is also hard to estimate the level of severity with no specific reference. However, when each quadrant is analyzed, it is immediately clear that pump card 8.4 shows a more severe issue than pump card 8.3. When viewed alone, it may be additionally possible to accurately estimate the percent fullness of the pump based on each quadrant. By analyzing quadrants B and D individually, it may be possible to determine that, for example, the percent fullness of the pump is lower than 50% in card 8.4, as quadrant D is completely empty, and the lower left corner of quadrant B is also empty. This indicates that the issue may be severe, whereas a card with some data in quadrant D would indicate a less severe issue.

In an embodiment, the prediction analyzer operation 606 may assign numbers or identifiers to different shapes or levels of severity. For example, pump card 8.3 may represent that the pump is approximately 65% full. The function may be able to recognize the percent fullness based on the shape of the card as described above, and indicate to the user that the pump card is displaying a #6 fluid pound, which may compromise all stages between 60% and 70% full. However, these numbers may be dynamic, and could change based on user preferences, algorithmic training, software, or other measures.

In the case of FIG. 8, the respective prediction outputs for each pump card 8.1 through 8.5 could be as illustrated in the following Table 4:

TABLE 4
Predictions for FIG. 8 Pump Cards

| | Full | Quad A | Quad B | Quad C | Quad D | |
|---|---|---|---|---|---|---|
| Card | Image | predic- | predic- | predic- | predic- | |
| ID | Prediction | tion | tion | tion | tion | Final |
| 8.1 | Fluid | Normal | Mild | Normal | Normal | Fluid |
| | Pound | | | | | Pound - |
| | | | | | | Begin |
| | | | | | | Pump Off |
| | | | | | | 95% full |
| 8.2 | Fluid | Normal | Moderate | Normal | Moderate | Fluid |
| | Pound | | | | | Pound - |
| | | | | | | Begin |
| | | | | | | Fluid |
| | | | | | | Pound |
| | | | | | | 75% full |
| 8.3 | Fluid | Normal | Severe | Normal | Severe | Fluid |
| | Pound | | | | | Pound - |
| | | | | | | Moderate |
| | | | | | | 65% full |
| 8.4 | Fluid | Severe | Very | Null | Very | Fluid |
| | Pound | | Severe | | Severe | Pound - |
| | | | | | | Severe |
| | | | | | | 45% full |
| 8.5 | Fluid | Very | Very | Null | Very | Fluid |
| | Pound | Severe | Severe | | Severe | Pound - |
| | | | | | | Very |
| | | | | | | Severe |
| | | | | | | 30% full |

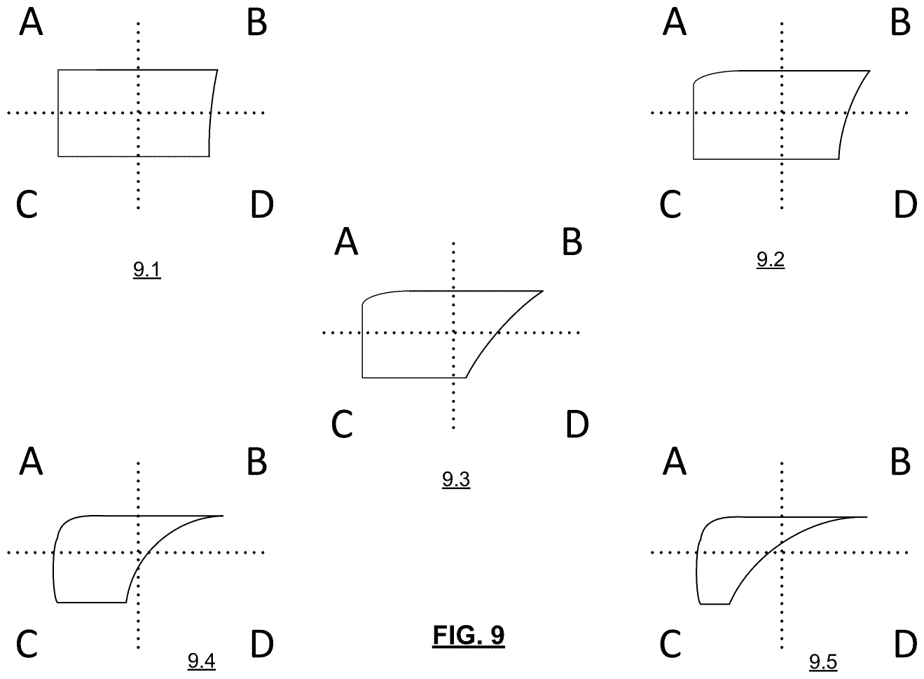

FIG. 9 illustrates varying levels of severity in a pump card condition that shows gas interference. These illustrations are meant as examples, and are not exhaustive of the potential displayed pump cards relating to this issue. Card 9.1 shows the least severe level of gas interference, while card 9.5 shows the most severe level of gas interference. As seen in pump cards 9.1 to 9.5, the shape of the pump card can vary drastically with the level of severity of the fault.

Similar to the above, it can be difficult to tell exactly what the issue is when looking at the card as a whole. In addition, it can be difficult to pinpoint the severity of the issue to determine the correct action to take. However, by analyzing each quadrant individually, it is easy to determine what the exact issue is, whether multiple issues may be overlapping, or the severity of the issue. When analyzed in quadrants, it would be immediately clear that card 9.4 is displaying a more severe issue than card 9.3, as quadrant D in card 9.4 is almost completely empty, whereas quadrant D in card 9.3 has much more data in it. In addition, the little coverage area found in quadrant C, indicates that it is that this is a very severe issue.

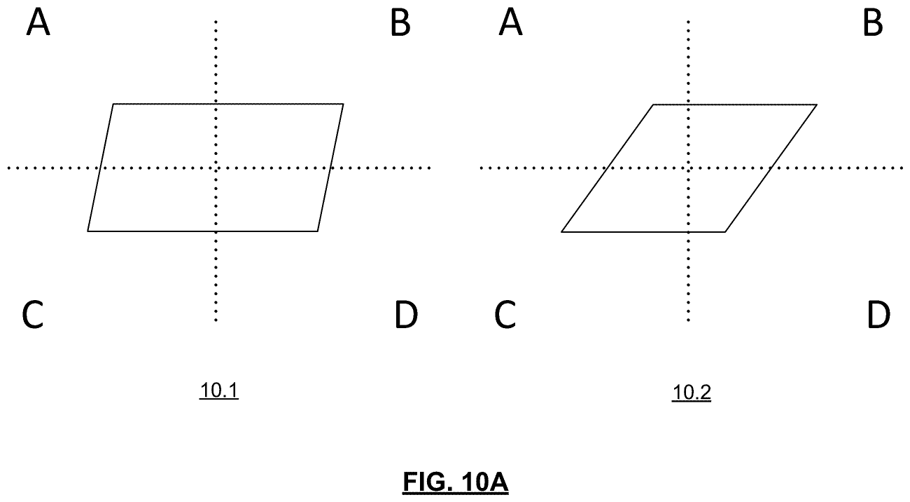

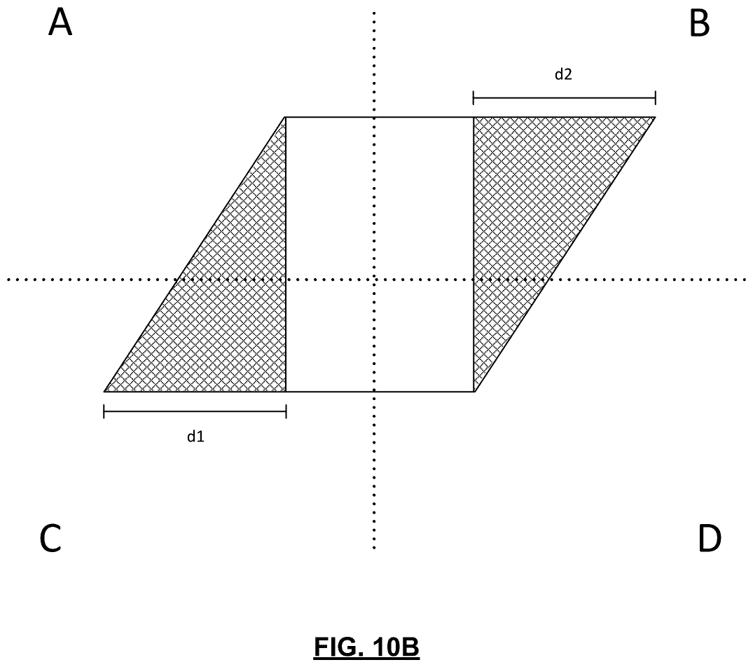

FIG. 10A illustrates two pump cards with two levels of a tubing movement condition. These illustrations are meant as examples, and are not exhaustive of the potential displayed pump cards relating to this issue. Pump card 10.1 shows a less severe tubing movement issue, and pump card 10.2 shows a more severe tubing movement issue. As mentioned previously, analyzing each quadrant individually helps to distinguish between the level of inefficiency displayed in the pump card, and can help determine the corrective action that must be taken.

As noted above, in some examples, at least some of the segment image prediction functions ƒⁱ can be rules based (as opposed to machine learning based models) based on historic knowledge. For example, in the case of pump cards 10.1 and 10.2, the distances displayed between the edge of the quadrants and the furthest point in the shape can be used by a rules-based image recognition function to determine a tubing movement inefficiency without complex calculation.

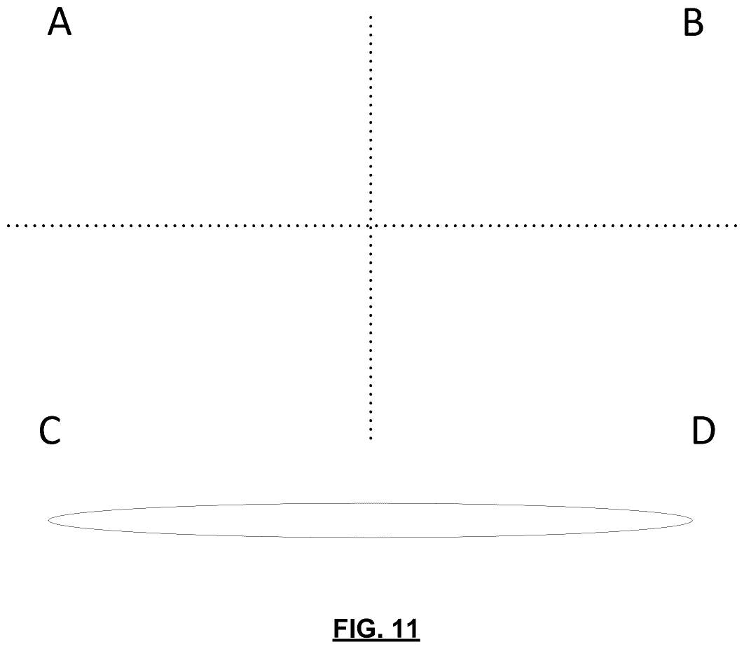

FIG. 10.B illustrates an example embodiment in which the system may measure the distances d1 and d2 in a pump card to determine the inefficiencies. By taking these measurements in, for example, quadrants B and C, the image recognition function would be able to determine the level of inefficiency of the pump, and suggest corrective action. In some examples, measurements from the quadrants can be taken to calculate a “net stroke” that can be used as an indication of efficiency. FIG. 11 illustrates a pump card corresponding to a flowing well or inoperative pump, where the shape displayed on the pump card is not shown anywhere in the segments. In an example embodiment, pump card analysis module 402 can be configured to determine when none of the quadrants include any pump card shape data and then attempt to look at a wider view of the pump card to determine if any information was missed. If no information is found, the pump card analysis module 402 may return a message to the user that the pump card did not display correctly, or may require operator intervention to properly assess the pump card. However, if information is found that was missed initially, the image recognition function may be able to re-segment the pump card into new quadrants, which may encompass a more accurate depiction of the pump card. In an embodiment, where human intervention is required, the image recognition function may give suggestions of changes to make to give a more accurate reading.

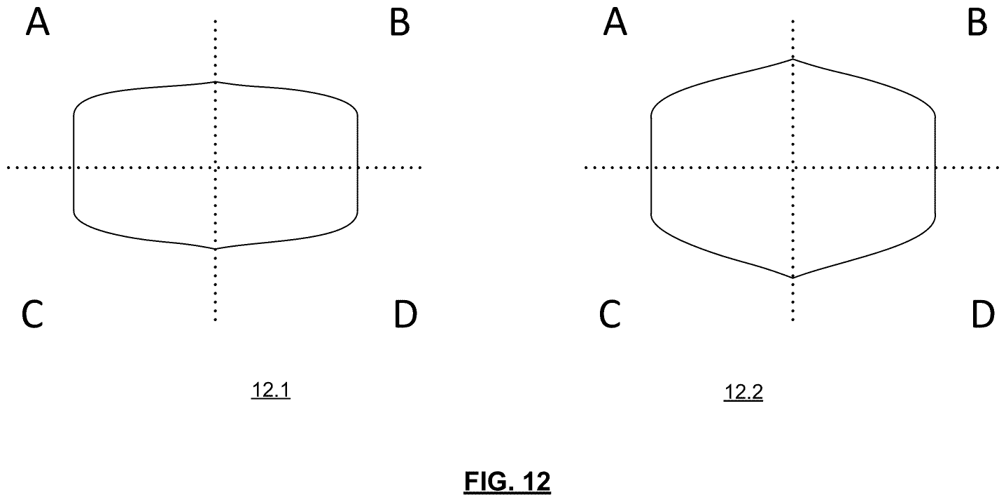

FIG. 12 illustrates two different levels of the pump card condition fluid friction. These illustrations are meant as examples, and are not exhaustive of the potential displayed pump cards relating to this issue. In some examples, quadrant analysis can be performed to determine x and y axis dimensions of the pump card shape as the predictions for each quadrant, and then these values compared against known stored value patterns by the prediction analyzer to generate an overall level of fluid friction. Thus, variations in the quadrant patterns are determined by analyzing the image shape in each segment, and may be matched to a library of processed data for quicker analysis.

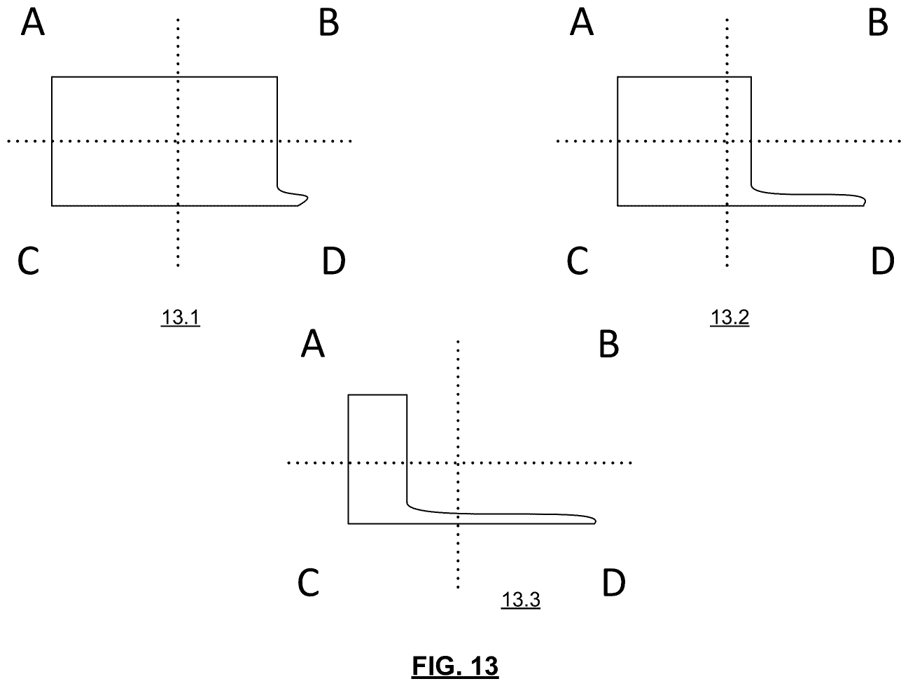

FIG. 13 illustrates a worn or split barrel condition with three levels of severity collectively represented in pumpcards 13.1, 13.2 and 13.3. These illustrations are meant as examples, and are not exhaustive of the potential displayed pump cards relating to this issue. As demonstrated previously, by analyzing each quadrant separately and viewing the results in connection with each other, the issue can be correctly determined, and the severity can be assessed. For example, if quadrant B is completely empty, as seen in card 13.3, this may be indicative of a severe issue, whereas if the issue is localized to quadrant D as seen in card 13.1, this may be indicative of a less serious issue.

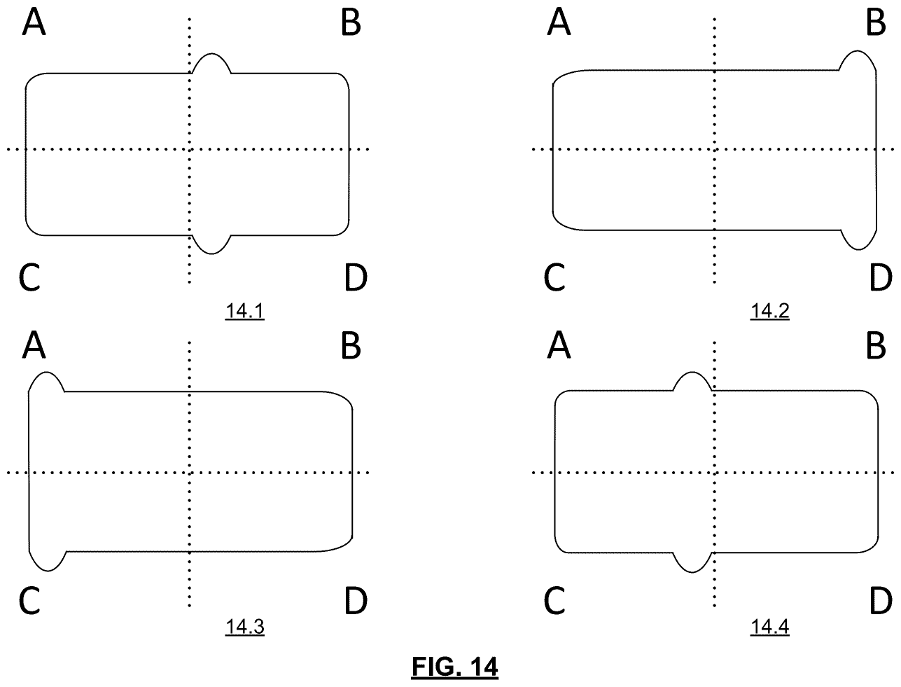

FIG. 14 illustrates different pump cards that may be displayed where they is a bent barrel or sticking pump condition. As shown in the figure, there are a large range of possible shapes that may be shown. These illustrations are meant as examples, and are not exhaustive of the potential displayed pump cards relating to this issue. By analyzing each quadrant, the pump card analysis module 402 can be able to accurately determine along which point of the path the issue presents itself. For example, in the case of FIG. 14, the respective prediction outputs for each pump card 14.1 through 14.4 could be as illustrated in the following Table 5:

TABLE 5
Predictions for FIG. 14 Pump Cards

| | Full | | | | | |
|---|---|---|---|---|---|---|
| | Image | Quad A | Quad B | Quad C | Quad D | |
| Card | Predic- | predic- | predic- | predic- | predic- | |
| ID | tion | tion | tion | tion | tion | Final |
| 14.1 | bent | Normal | Problem- | Normal | Problem- | Bent |
| | barrel | | left | | left | Barrel |
| | or | | | | | |
| | sticking | | | | | |
| | pump | | | | | |
| 14.2 | bent | Normal | Problem- | Normal | Problem- | Bent |
| | barrel | | right | | right | Barrel |
| | or | | | | | |
| | sticking | | | | | |
| | pump | | | | | |
| 14.3 | bent | Problem- | Normal | Problem- | Severe | Bent |
| | barrel | left | | left | | Barrel/ |
| | or | | | | | Sticking |
| | sticking | | | | | Pump |
| | pump | | | | | |
| 14.4 | bent | Problem- | Normal | Problem- | Normal | Bent |
| | barrel | right | | right | | Barrel/ |
| | or | | | | | Sticking |
| | sticking | | | | | Pump |
| | pump | | | | | |

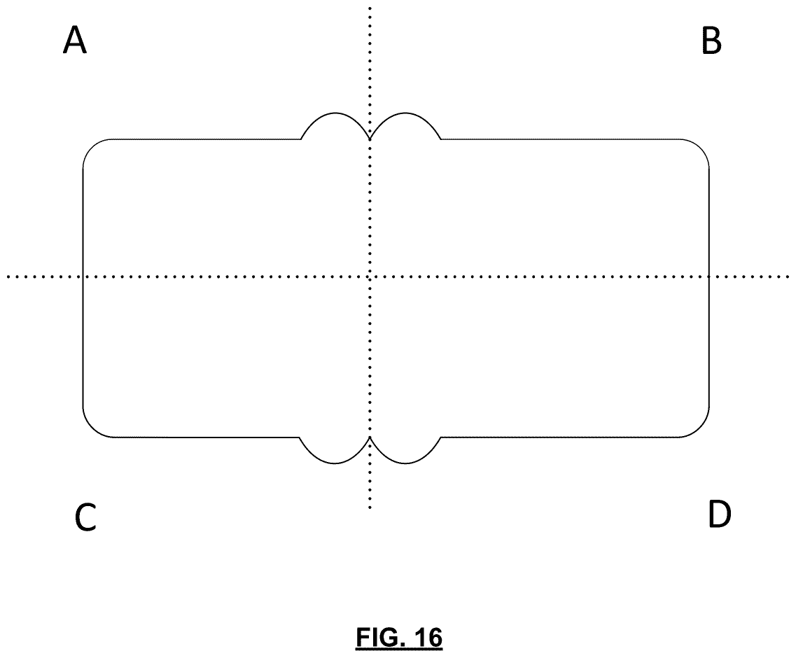

By way of example of a possible miss-categorization detection, in the case of FIG. 16, the full image prediction may be “bent barrel or sticking pump”, and the segment predictions were collectively “Quad A: problem right; Quad B: problem left; Quad C: problem right; Quad D: problem left” the prediction analyzer 606 may be configured to determine that the above sequence of segment predictions does not correspond to a known “bent barrel or sticking pump” condition, and thus an error has been made in the full image prediction. Furthermore, prediction analyzer 606 may be configured to determine that such an error indicates a pump card shaped that corresponds more closely to a fluid friction condition. In such case, the prediction analyzer 606 may instruct segment analyzer to redo the segment analysis using the set of segment predictions functions that correspond to the fluid friction condition, and then analyze the new segment prediction results to determine if they confirm a fluid friction condition. The output prediction can then be “fluid friction condition” with an appropriate severity indicator and confidence score as based on the segment analyzer output.

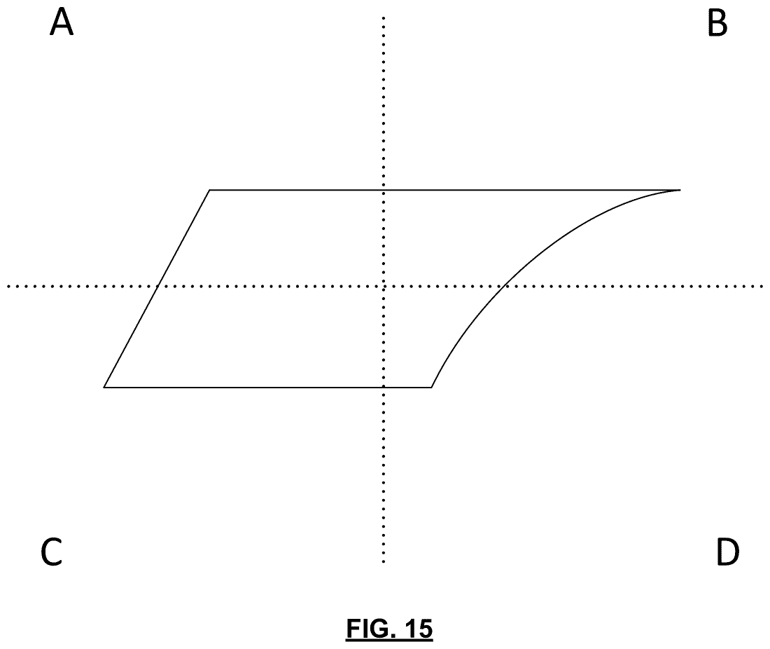

In an example of detecting multiple issues in a pump card, FIG. 15 illustrates a pump card with multiple error conditions. When viewed as a whole, it may be easy to mistakenly assess the issue as only a tubing movement issue. Looking only at quadrant A and C, it could be the case. However, when viewing the shape of especially quadrant B, it is clear that there is another issue present, specifically a gas interference issue. In some examples, by analyzing the data of each quadrant individually, the image recognition function may be able to easily determine the combination of issues present, and which parts of the pump's operation they are affecting. In addition, using measurement methods previously discussed, the function may be able to assess the level of severity for both the gas interference, and the tubing movement. Having these measurements allows the function to determine the corrective action that must be taken, and output this information to the user. In some examples, multiple segment prediction functions configured for different error conditions can be used for each quadrant, with the prediction analyzer identifying the most likely multiple error conditions based on the total collection of predictions. Such a determination could be rules based, based on a look-up table, and/or incorporate a trained machine learning based model. In each case, the predictions can be based on rules and/or an ML model that have been configured based on historic knowledge.

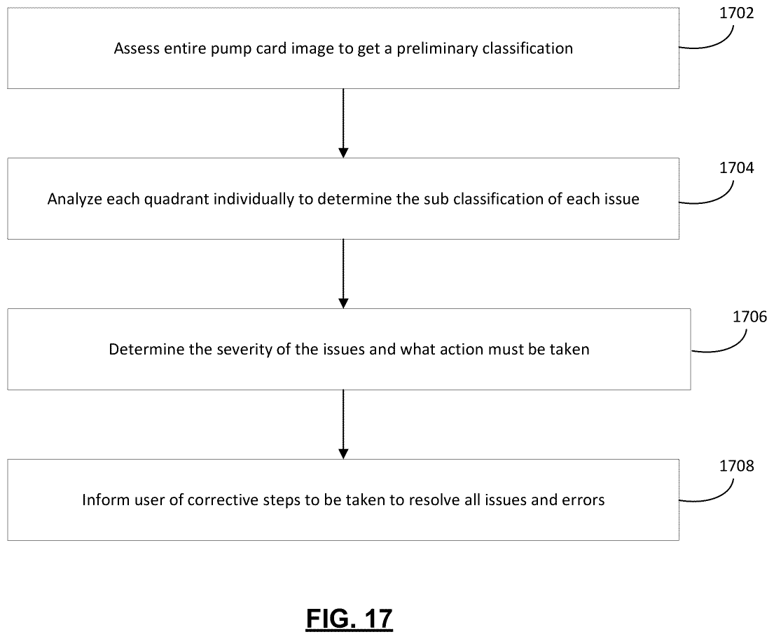

FIG. 17 shows a flowchart demonstrating an example algorithm to be followed by the image recognition function. At step 1702, the full pump card image is assessed and a preliminary classification is given. This classification could be a full pump reading, or could be an error or issue, such as pump hitting up or down, fluid pound, gas interference, tubing movement, worn plunger or traveling valve, worn standing valve, inoperative pump, drag friction, fluid friction, worn or split barrel, or bent barrel sticking to pump. At this preliminary stage, one or many issues are identified.

At step 1704, each quadrant is assessed separately to determine the sub classification of the pump card. At this stage, the image recognition function may determine if there are multiple issues present, or may determine the severity of the issues. By breaking the pump card down into multiple image segments, the pump card can be interpreted in several ways, giving a wider range of possible issues, and more precise results. The result may be based on one segment, or a range of segments.

At step 1706, the cause of the issue is determined, as well as what corrective action should be taken to resolve the issue (e.g., slow down or speed up the pump). At step 1708, this information is relayed to the user, who can then take corrective action. The image recognition function may also be able to provide a confidence level or likelihood of each potential issue and corrective action, so more experienced technicians can use the information to make an informed decision where the pump card may be difficult to read.

It should be noted that while the above paragraphs have referred to quadrants, the image recognition function may split up the pump card image into any number of segments, which can each be individually assessed. Each quadrant may even be split further into sub-quadrants, where pump card images require more precise analysis to return correct results.

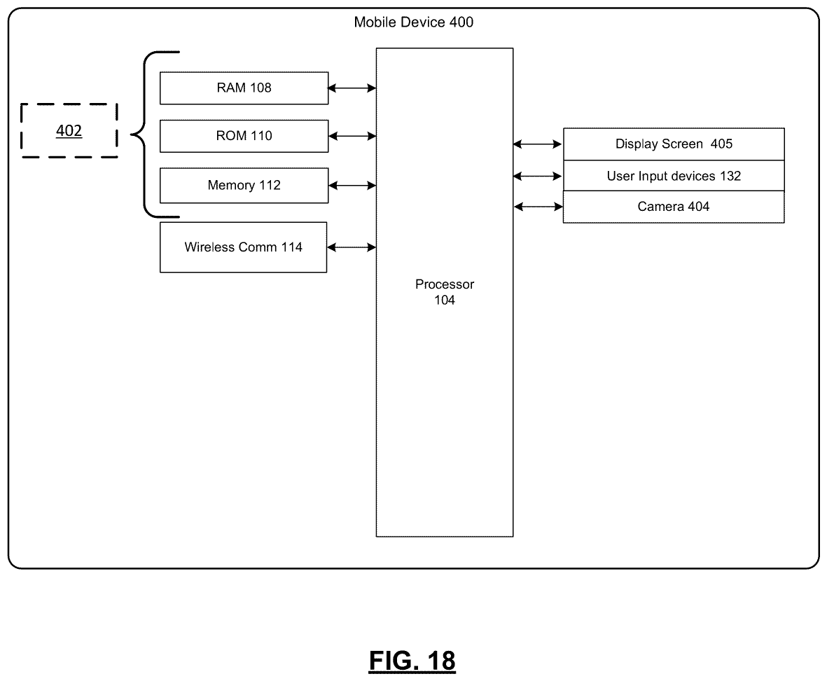

Reference is next made to FIG. 18 which illustrates in simplified block diagram form a mobile device 400 in which example embodiments described in the present disclosure may be applied. The mobile device 400 may include, but is not limited to, a handheld device, such as a smartphone or tablet or a laptop or notebook computer. The mobile device 400 may be equipped for cellular communication, Wi-Fi™ communications, or both. In addition to cellular and Wi-Fi™ communications, the mobile device 400 may also be equipped for Bluetooth™ and/or NFC (near-field communication) communications.

The mobile device 400 illustratively includes a rigid case or housing which carries the electronic components of the mobile device 400. The housing may be elongated vertically, or may take on other sizes and shapes (including clamshell housing structures). The mobile device 400 includes a controller comprising at least one processor 104 (such as a microprocessor) which controls the overall operation of the mobile device 400.

The processor 104 interacts with other components, such as input device(s) 132, Random Access Memory (RAM) 108, Read Only Memory (ROM) 110, wireless communications subsystem 114 for exchanging radio frequency signals with a wireless network that is part of the network 416, a display screen 405 such as a color liquid crystal display (LCD) or active-matrix organic light-emitting diode (AMOLED) display, persistent (non-volatile) memory 112 which may be flash erasable programmable read only memory (EPROM) memory (flash memory) or other suitable form of memory, and sensor(s) including a camera 133, The components of the mobile device 400 are coupled via a communications bus (not shown) which provides a communication path between the various components.

The input device(s) 132 may include a keyboard or keypad, one or more buttons, one or more switches, a touchpad, a rocker switch, a thumbwheel, or other type of input device, and/or a touchscreen or touch-sensitive display that is integrated into display screen 131.

User-interaction with a GUI presented on the display screen 131 can be performed using the input devices 132. Information, such as text, characters, symbols, images, icons, and other items are rendered and displayed on the display screen 131 via the processor 104. The processor 104 may interact with one or more sensors, including camera 404.

Operating system software executed by the processor 104 is stored in the persistent memory 112, such as flash memory, but may be stored in other types of memory devices, such as ROM 110 or similar storage element. System software, software modules, specific device applications, or parts thereof, may be temporarily loaded into a volatile store, such as RAM 108, which is used for storing runtime data variables and other types of data or information. Communications signals received by the mobile device 400 may also be stored in the RAM 108. Although specific functions are described for various types of memory, this is merely one example, and a different assignment of functions to types of memory may be used in other embodiments.

The processor 104, in addition to its operating system functions, enables execution of software applications on the mobile device 400. A predetermined set of applications or software modules that control basic device operations, such as voice communications, data communications, etc., may be installed on the mobile device 400 during manufacture. Installed applications also include the software and data required to implement the pump card analysis module 402.

In example embodiments, mobile device 400 is a two-way wireless Radio Frequency (RF) communications device having data and/or voice communications capabilities. The mobile device 400 may have the capability to communicate with other computer systems via the Internet (e.g., network 416). The wireless communication subsystem 114 exchanges radio frequency signals with the wireless network.

The coding of software for carrying out the above-described methods described is within the scope of a person of ordinary skill in the art having regard to the present disclosure. Machine-readable code executable by one or more processors of one or more respective devices to perform the above-described method may be stored in a machine-readable medium such as a memory of the mobile device 400.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. For example, the methods may be implemented in software stored in a pre-recorded storage device or other similar machine readable medium having executable program instructions stored thereon for performing the methods described herein, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory. Alternatively, the methods may be implemented in hardware components or combinations of hardware and software such as, for example, ASICs, special purpose computers, or general purpose computers.

The present disclosure may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A method comprising:
obtaining, at a mobile device, an input image representing a pump card;
mapping, based on the input image, the pump card to one of a plurality of possible pump operating conditions;
outputting, at the mobile device, the mapped pump operating condition.

2. The method of claim 1, wherein the mapping of the input pump card involves classifying the pump card based on known historical data.

3. The method of claim 1 wherein the mapping of the pump card comprises classifying the input image as one of a plurality of possible pump operating conditions using trained machine learning based image classification model.

4. The method of claim 1, wherein the mapping of the pump card to one of a plurality of possible pump operating conditions comprises:
segmenting the input image into a set of multiple image segments and mapping each of the respective image segments using a respective segment mapping function to generate respective segment predictions and determining the mapped pump operating condition based on the respective segment predictions.

5. The method of claim 1, wherein the mapping of the pump card to one of a plurality of possible pump operating conditions comprises:
generating a full image prediction for the input image;
segmenting the input image into a set of multiple image segments and mapping each of the respective image segments using a respective segment mapping function to generate respective segment predictions; and
determining the mapped pump operating condition based on the full image prediction and the respective segment predictions.

6. The method of claim 1, wherein the mapping of the pump card to one of a plurality of possible pump operating conditions comprises:
selecting, based on the full image prediction, the respective segment mapping function to use for mapping each of the respective image segments.

7. The method of claim 6 wherein determining the mapped pump operating condition based on the full image prediction and the respective segment predictions comprises determining an overall operating condition based on the full image prediction and determining a severity or degree of the overall operating condition based on the respective segment predictions.

8. The method of claim 6 wherein determining the mapped pump operating condition based on the full image prediction and the respective segment predictions comprises determining an overall operating condition based on the full image prediction and assessing a validity of the overall operating condition based on the respective segment predictions.

9. The method of claim 1 wherein the mapping is performed at the mobile device.

10. The method of claim 1 comprising, determining at the mobile device if the mobile device has the ability to perform the mapping, and if so, then performing the mapping at the mobile device, and if not, then sending a request from the mobile device to a remote server to perform the mapping and provide the mapped pump operating condition to the mobile device.

11. A mobile device comprising one or more processors and one or more memories storing instructions that when executed by the one or more processors configure the mobile device to perform the method of:
obtaining, at a mobile device, an input image representing a pump card;
mapping, based on the input image, the pump card to one of a plurality of possible pump operating conditions;
outputting, at the mobile device, the mapped pump operating condition.

12. The device of claim 11, wherein the mapping of the input pump card involves classifying the pump card based on known historical data.

13. The device of claim 11 wherein the mapping of the pump card comprises classifying the input image as one of a plurality of possible pump operating conditions using trained machine learning based image classification model.

14. The device of claim 11, wherein the mapping of the pump card to one of a plurality of possible pump operating conditions comprises:
segmenting the input image into a set of multiple image segments and mapping each of the respective image segments using a respective segment mapping function to generate respective segment predictions and determining the mapped pump operating condition based on the respective segment predictions.

15. The device of claim 11, wherein the mapping of the pump card to one of a plurality of possible pump operating conditions comprises:
generating a full image prediction for the input image;
segmenting the input image into a set of multiple image segments and mapping each of the respective image segments using a respective segment mapping function to generate respective segment predictions; and
determining the mapped pump operating condition based on the full image prediction and the respective segment predictions.

16. The device of claim 11, wherein the mapping of the pump card to one of a plurality of possible pump operating conditions comprises:
selecting, based on the full image prediction, the respective segment mapping function to use for mapping each of the respective image segments.

17. The device of claim 16 wherein determining the mapped pump operating condition based on the full image prediction and the respective segment predictions comprises determining an overall operating condition based on the full image prediction and determining a severity or degree of the overall operating condition based on the respective segment predictions.

18. The device of claim 16 wherein determining the mapped pump operating condition based on the full image prediction and the respective segment predictions comprises determining an overall operating condition based on the full image prediction and assessing a validity of the overall operating condition based on the respective segment predictions.

19. The device of claim 11, the method further comprising, determining at the mobile device if the mobile device has the ability to perform the mapping, and if so, then performing the mapping at the mobile device, and if not, then sending a request from the mobile device to a remote server to perform the mapping.

20. A non-transient computer readable medium storing instructions that configure a mobile devices to perform a method comprising:
obtaining, at a mobile device, an input image representing a pump card;
mapping, based on the input image, the pump card to one of a plurality of possible pump operating conditions;
outputting, at the mobile device, the mapped pump operating condition.
